(19) United States
(12) Patent Application Publication
(10) Pub. No.: US 2003/0181245 A1
(43) Pub. Date: Sep. 25, 2003

(54) Downhole universal joint assembly

(76) Inventor: Joel David Shaw, Houston, TX (US)

Correspondence Address: WILLIAM B. PATTERSON, MOSER, PATTERSON & SHERIDAN, L.L.P., Suite 1500, 3040 Post Oak Blvd., Houston, TX, 77056, US

(21) Appl. No.: 10/102,167

(22) Filed: Mar. 20, 2002

(51) Int. Cl. F16D 3/06; E21B 17/02

(52) U.S. Cl. 464/163

(57) ABSTRACT

A universal joint assembly having a shaft and one or more housings. The housing has an opening for coupling with the shaft. The shaft pivots against a seat disposed in the opening during articulation. The joint assembly further includes one or more torque transmitting rollers disposed in one or more roller slots formed on the rotating surfaces. The shaft is retained axially using a retaining member disposed beyond the torque section. The joint assembly is sealed from drilling fluids using a seal assembly having a seal member biased against a seal cap disposed on the shaft. The joint assembly further includes a grease fitting axially disposed for introducing grease into the joint assembly.

### BACKGROUND OF THE INVENTION

1. Field of the Invention

The present invention generally relates to an apparatus for use in a wellbore. Particularly, the invention relates to an apparatus for forming a wellbore. More particularly, the invention relates to an apparatus for coupling a downhole motor to a downhole tool. More particularly still, the invention relates to an apparatus for transferring torque from a downhole motor to an output shaft to rotate a downhole tool.

2. Description of the Related Art

Downhole mud motors have many applications in the oil and gas industry. In one instance, downhole mud motors may be used to apply torque to a drill bit or other tools requiring rotation. Typically, the mud motor is placed at the bottom of the drill string and an output shaft is used to couple the motor to a drill bit. Drilling fluid or “mud” pumped through the drill string to the mud motor produces a mechanical output to rotate the output shaft and the drill bit.

A common type of mud motor is a positive displacement motor having an elongated, helically-shaped rotor within a corresponding helically shaped stator. FIG. 1 is a schematic cross sectional view of a power section 1 of such a positive displacement motor. FIG. 1A is a schematic cross sectional view of the downhole motor shown in FIG. 1. Similar elements are similarly numbered and the figures will be described in conjunction with each other. The power section 1 includes an outer stator 2, an inner rotor 4 disposed within the stator 2. An elastomeric member 7 is formed between the stator 2 and the rotor 4 and is typically a part of the stator 2. The rotor 4 includes a plurality of lobes 6 formed in a helical pattern around the circumference of the rotor 4. The stator 2 includes a plurality of receiving surfaces 8 formed in the elastomeric member 7 for the lobes 6. The number of receiving surfaces 8 is one more than the number of lobes 6. The lobes 6 are produced with matching lobe profiles and a similar helical pitch compared to the receiving surfaces 8 in the stator 2. Thus, the rotor 4 can be matched to and inserted within the stator 2. Fluid flowing from the inlet 3 through the motor creates hydraulic pressure that causes the rotor 4 to rotate within the stator 2, as well as precess around the circumference of the receiving surfaces 8. Thus, a plurality of progressive cavities 9 is created that progresses from the inlet 3 to the outlet 5 as the rotor 4 is rotated within the stator 2. Fluid contained within the cavities 9 is thereby exhausted through the outlet 5. The hydraulic pressure, causing the rotor 4 to rotate, provides output torque for various tools attached to the motor.

As seen in FIG. 1A, the rotor 4 rotates about its longitudinal axis in the stator 2 as a result of the fluid pressure. At the same time, the rotor 4 also orbits within the stator 2 eccentrically about the longitudinal axis of the stator 2. The eccentric orbital rotation of the rotor 4 presents difficulties in transferring the torque to an output shaft to rotate the output shaft in a concentric manner.

Generally, universal joint assemblies, “U-joints”, are used to transfer the torque generated from the eccentric orbit and rotation of the rotor to cause a concentric rotation of the output shaft to drive the drill bit. Typically, two U-joints are required to make the transition. First, the output end of the rotor is connected to a first U-joint. Then a shaft is used to couple the first U-joint to the second U-joint. Finally, the opposite end of the second U-joint is connected to a concentrically rotating output shaft. In this manner, the two U-joints may facilitate the concentric rotation of the output shaft by the eccentrically rotating rotor.

U-joints are also used in conjunction with a downhole mud motor in other downhole applications. For example, a mud motor may be designed with a bent housing for use in directional drilling. In addition, mud motors may include a mechanism by which the housing may be bent at a suitable angle for directional drilling. In either case, a U-joint may be used to traverse the bend in the housing.

An example of a prior art universal joint assembly is shown in U.S. Pat. No. 5,704,838 issued to Teale. Teale discloses an universal joint assembly having a coupling hub member and a female coupling member. The female coupling member includes a receptacle at one end for receiving a pivot end of the coupling hub member. The joint includes a central bearing structure interposed between the coupling hub member and female coupling member for enabling the coupling members to pivot up to a maximum pivot angle with respect to each other about a coupling axis. The universal joint also includes a plurality of torque transmitting rollers, each received in a different roller slot and spaced apart about the periphery of the coupling hub member near its pivot end. The roller slots are formed on both the coupling hub member and female coupling member and enable the torque transmitting rollers to transmit torque between the coupling members while rolling with respect to the roller surfaces as the coupling members pivot about the coupling axis. The universal joint also includes a spherical seal structure associated with the coupling hub member to protect the interior of the joint from the drilling fluid. Moreover, each universal joint employed in the down-hole mud motor is oriented in the mud motor with the receptacle of the female coupling member facing downwardly away from the direction of fluid flow through the motor.

In use, U-joints are subjected to very high torques and operate in a very hostile environment. One problem with prior mud motor U-joints involves the seal structure that protects the interior of the joint. Seals for U-joints used in mud motor applications must allow smooth articulation as the joint rotates, while protecting the internal bearing surfaces of the joint from extreme pressure, pressure variations, and high velocity drilling fluid. In Teale, the seal structure is disposed between the coupling hub member and the female coupling member. One drawback of this design is that the seal structure reduces the torque transfer capacity of the joint. Generally, torque transfer capacity depends on the radius of a rotating member. Because the radius of the coupling hub member is reduced to accommodate the seal structure, the coupling hub member's torque transfer capacity is also reduced.

Another drawback of some prior art U-joint designs is the imbalance of the joint caused by the grease fitting. Grease is added to the joint to reduce the friction between the members during articulation. In Teale, the greasing fitting is placed on one side of the joint. Thus, the greasing fitting will cause an axial imbalance during rotation.

Therefore, there is a need for an apparatus for transferring torque from a positive displacement motor to concentrically rotate an output shaft. There is a further need for an apparatus for maximizing the torque transfer between articulating members in a given fixed diameter joint housing. There is yet a further need for an apparatus to input grease into the joint without creating an axial imbalance during rotation of the joint.

### SUMMARY OF THE INVENTION

The present invention generally provides a universal joint assembly for transferring torque. The joint assembly includes one or more housings having at least one outer roller slot. A shaft having at least one inner roller slot is coupled to the one or more housings. A torque transmitting member is maintained between the outer roller slot and the inner roller slot. A retaining member is used to axially retain the shaft within the housing. The joint assembly is protected from the drilling fluid using a seal assembly.

In another aspect, the joint assembly further includes a pivoting structure contacting a seat to facilitate the shaft pivoting in the housing. The seal assembly includes a seal member biased against a seal cap disposed on the shaft. The seal cap has a spherical sealing surface for contacting the seal member. The joint assembly may further include a grease fitting for introducing grease into the joint assembly.

### BRIEF DESCRIPTION OF THE DRAWINGS

So that the manner in which the above recited features and advantages of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a schematic cross sectional view of a power section of a progressive cavity motor in the prior art.

FIG. 1A is a schematic cross sectional view of the power section shown in FIG. 1.

FIG. 2 is a schematic cross sectional view of an universal joint assembly of the present invention.

FIG. 3 is a schematic cross sectional view of one joint of the universal joint assembly shown in FIG. 2.

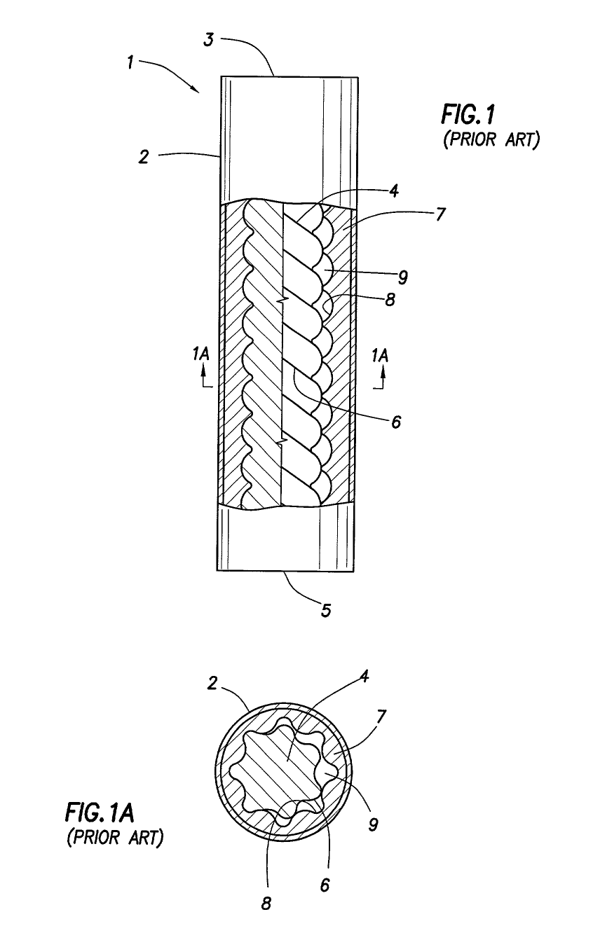

### DETAILED DESCRIPTION OF THE PREFERRED EMBODIMENT

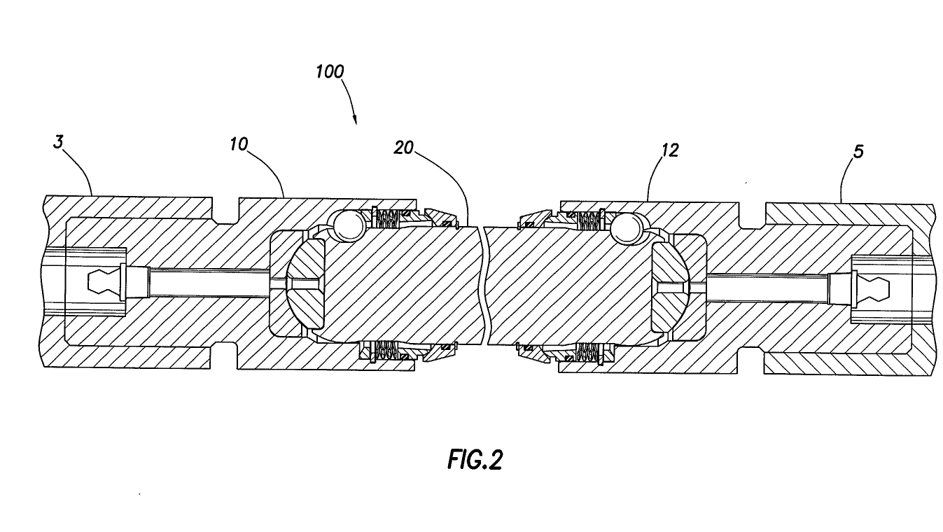

FIG. 2 is a schematic drawing of an universal joint assembly 100 according to one aspect of the present invention. The joint assembly includes a pair of housings 10, 12 and a shaft 20 for coupling the two housings 10, 12. The joint assembly may be used to transfer torque from a downhole motor 3 to an output shaft 5 by connecting one of the housings 12 to the downhole motor 3 and the other housing 10 to the output shaft 5.

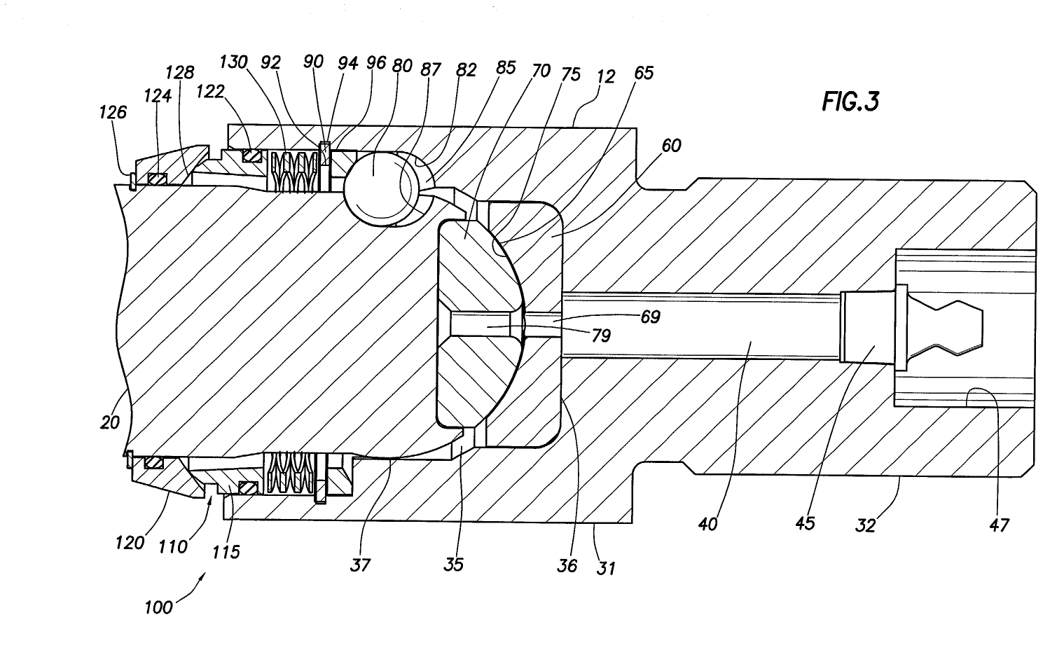

FIG. 3 is schematic view of one joint of the universal joint assembly 100. The housings 10, 12 are identical and each includes a first end 31 and a second end 32. Preferably, an outer diameter of the first end 31 is larger than an outer diameter of the second end 32. The second end 32 may have threads (not shown) formed on an outer surface for attachment to a downhole tool, such as a downhole motor 3 or an output shaft 5. The first end 31 includes an opening 35 for receiving the shaft 20. The opening 35 fluidly communicates with the second end 32 of the housing through an axially disposed channel 40 in the housing 12. Preferably, the channel 40 shares the same longitudinal axis with the housing 12. A counterbore 47 may be formed in the second end 32 for maintaining a grease fitting 45 or some other means for injecting a lubricant into the opening 35. This location shields the grease fitting 45 from any fluid in the wellbore.

The opening 35 for receiving the shaft 20 is defined by an end wall 36 and sidewalls 37. One or more longitudinally extending outer slots 82 are formed on the sidewall 37 of the opening 35. Preferably, the slots 82 are aligned radially about the longitudinal axis of the housing 12. A removable seat 60 having a concave surface 65 for mating with the shaft 20 may be disposed against the end wall 36 of the housing 12. The seat 60 may have a hole 69 for maintaining fluid communication between the opening 35 and the channel 40. Grooves (not shown) extending radially from the hole 69 may be formed on the concave surface 65 of the seat 60 to facilitate fluid transfer and enhance lubrication between the contact surfaces 65, 20. Alternatively, the end wall 36 may include a concave surface for directly contacting with the shaft 20, thereby eliminating the need of the removable seat 60.

The shaft 20 is at least partially disposed in the opening 35 and pivots against the seat 60. A removable pivoting structure 70 having an arcuate outer surface 75 may be disposed at the end of the shaft 20 to contact the concave surface 65 of the seat 60. Alternatively, an arcuate surface may be formed on the end of the shaft 20, thereby eliminating the need for the removable pivoting structure 70. The pivoting structure 70 may include a hole 79 to facilitate disassembly of the pivoting structure 70. In addition to pivoting, the pivoting structure 70 also supports the axial thrust load applied to the housing 12. Due to the wear and tear experienced by the contact surfaces 65, 75, a universal joint 100 having a removable pivoting structure 70 and seat 60 may be more advantageous in reducing costs and downtime.

Torque is transferred between the shaft 20 and the housing 12 by one or more torque members 80 disposed about the periphery of the shaft 20. Preferably, the torque members 80 comprise rollers. Each roller 80 transmitting torque is disposed in a roller receiving compartment 85 formed by the outer roller slot 82 on the housing 12 and a corresponding inner roller slot 87 formed on an outer surface of the shaft 20. The rollers 80 provide a rolling surface for minimizing wear and tear during torque transfer and articulation. In this manner, torque is effectively transferred between the shaft 20 and the housings 10,12.

An axial retention means 90 is used to retain the shaft 20 in the opening 35 in the event the joint assembly 100 encounters a tensile force. Preferably, the axial retention means 90 is located past the torque transferring section so as not to interfere with the cross-sectional area of the housing 10, 12. The axial retention means 90 may comprise a retaining member 92 at least partially disposed in a groove 94 formed on the sidewall 37 of the opening 35. Preferably, the retaining member 92 comprises a circular ring or a c-shaped ring.

The axial retention means 90 may further include a keeper 96 to assist the retaining member 92 to retain the shaft 20 in the housing 12. In some instances, the force exerted by the rollers 80 on the retaining member 92 may cause the retaining member 92 to breakdown prematurely. By placing a keeper 96 between the retaining member 92 and the rollers 80, the keeper 96 may distribute the force exerted by the rollers 80 as an even shear force against the retaining member 92. As a result, the keeper 96 may increase the longevity of the retaining member 92.

The opening 35 is sealed from fluids in the drill string using a seal assembly 110 designed to maximize an outer diameter of the shaft 20 and minimize an inner diameter of the housing 12. The seal assembly 110 includes an annular seal member 115 at least partially disposed in the opening 35 that mates with an annular seal cap 120. An o-ring 122 may be disposed between an outer surface of the seal member 115 and the sidewalls 37. The seal cap 120 is slidably disposed on the shaft 20. Another o-ring 124 may be disposed between the seal cap 120 and the shaft 20 to enhance the seal. The seal assembly 110 is biased between the retaining member 92 and an end stop 126 on the shaft 20. Specifically, the seal member 115 is biased against a sealing surface 128 of the seal cap 120 using a biasing member 130 disposed between the retaining member 92 and the seal member 115. The seal cap 120 abuts the end stop 126 to maintain the bias. The end stop 126 may comprise a c-shaped ring or an abutment formed on the shaft 20. Alternatively, the biasing member 130 may be disposed between the end stop 126 and the seal cap 120. In which case, a person of ordinary skill in the art may recognize that the seal member 115 may be formed as an integral part of the housing 12. The biasing member 130 allows for a continuous contact despite varying axial positions of the shaft 20 relative to the housing 12 due to wear, tolerance, buildup, or operation under tension. Preferably, the sealing surface 128 comprises a spherically shaped surface so that a continuous contact is maintained regardless of articulation. Further, by placing the seal cap 120 on the shaft 20, shaft clearance is maximized during articulation. In this manner, the seal assembly 110 effectively seals the opening 35 from drilling fluids without compromising the torque transferring efficiency.

In operation, one end 10 of the joint assembly 100 connects to an output shaft 5 and the other end 12 connects to a motor rotor 3 as illustrated in FIG. 2. As discussed above, the rotor 3 may rotate about its longitudinal axis and eccentrically orbit about the stator axis (not shown). To minimize the effect of the eccentric orbit of the rotor 3, the shaft 20 pivots between the housings 10, 12 to rotate the output shaft 5 in a concentric manner. To transfer torque, the rollers 80 roll along the inner and outer roller slots 82, 87 between the shaft 20 and the housings 10, 12. During operation, the only contact between the shaft 20 and the housing 10, 12 during articulation is a rolling contact between the rollers 80 and the slots 82, 87. The roller and slot design prevents the housings 10, 12 and the shaft 20 from rubbing each other during articulation, thereby reducing wear and increasing operational lifetime. Further, the grease fitting 45 is placed in a manner that facilitates the concentric rotation of the output shaft 5.

The seal assembly 110 provides a continuous seal between the shaft 20 and the housing 10, 12 during operation. Because the seal cap 120 is disposed on the shaft 20, the seal cap 120 pivots and rotates when the shaft 20 pivots and rotates. Moving with the shaft 20 allows the spherical contact surface 128 to provide a continuous seal with the sealing member. Further, biasing member 130 maintains the seal even when the shaft 20 experiences a tensile force.

While the foregoing is directed to embodiments of the present invention, other and further embodiments of the invention may be devised without departing from the basic scope thereof, and the scope thereof is determined by the claims that follow.

1. An universal joint assembly, comprising:
one or more housings, the one or more housings having at least one outer roller slot formed on an inner surface thereof;
a shaft coupled to the one or more housings, the shaft having at least one inner roller slot formed on an outer surface thereof, wherein each of the at least one inner roller slot aligns with one of the at least one outer roller slot to maintain a roller;
a retaining member; and
a seal assembly having:
a seal cap disposed on the shaft; and
a seal member biased against the seal cap.

2. The universal joint assembly of claim 1, wherein the one or more housings further comprise:
an opening disposed at a first end of the one or more housings for coupling with the shaft; and
a fluid channel disposed in the one or more housings, the fluid channel placing the opening in fluid communication with a second end of the one or more housings.

3. The universal joint assembly of claim 2, further comprising a grease fitting at least partially disposed in the fluid channel at the second end of the one or more housings.

4. The universal joint assembly of claim 3, wherein the grease fitting is substantially radially balanced inside the one or more housings.

5. The universal joint assembly of claim 1, wherein the retaining member is disposed between the roller and the seal member.

6. The universal joint assembly of claim 5, wherein the seal cap includes a spherical surface for contacting the seal member.

7. The universal joint assembly of claim 6, wherein a biasing member is disposed between the retaining member and the seal member.

8. The universal joint assembly of claim 7, wherein the seal cap abuts an end stop.

9. The universal joint assembly of claim 6, wherein the seal cap abuts an end stop.

10. The universal joint assembly of claim 9, wherein a biasing member is disposed between the end stop and the seal cap.

11. The universal joint assembly of claim 5, further comprising a force distribution member disposed between the roller and the retaining member.

12. The universal joint assembly of claim 11, further comprising a thrust bearing assembly disposed between the one or more housings and the shaft.

13. The universal joint assembly of claim 12, wherein the thrust bearing assembly comprises a seat and a pivoting structure, wherein the pivoting structure has an arcuate surface that contacts a concave surface of the seat.

14. The universal joint assembly of claim 13, wherein each of the seat and the pivoting structure has a hole for fluid communication with the channel.

15. The universal joint assembly of claim 12, wherein the shaft includes an arcuate surface at an end thereof, which contacts a concave surface in the one or more housings.

16. A downhole motor transmission, comprising:
one or more housings, the one or more housings having:
at least one outer roller slot formed on an inner surface thereof; and
a central axial channel;
a shaft coupled to the one or more housings, the shaft having at least one inner roller slot formed on an outer surface thereof, wherein each of the at least one inner roller slot aligns with one of the at least one outer roller slot to maintain a roller;
a retaining member for retaining the shaft at least partially within the one or more housings;
a seal assembly; and
a fitting disposed in the central axial channel.

17. The downhole motor transmission of claim 16, wherein the seal assembly includes:
a seal cap disposed on the shaft; and
a seal member coupled to the seal cap using a biasing member.

18. The downhole motor transmission of claim 17, wherein the one or more housings further comprise an opening disposed at an end of the one or more housings for coupling with the shaft, wherein the opening is in fluid communication with the axial channel.

19. The downhole motor transmission of claim 18, wherein the shaft comprises an arcuate outer surface disposed at an end thereof.

20. The downhole motor transmission of claim 19, wherein the one or more housings include a seat having a concave surface for contacting the arcuate outer surface.

21. The downhole motor transmission of claim 17, wherein the biasing member is disposed between the retaining member and the seal member.

22. The downhole motor transmission of claim 21, wherein the seal member is biased against a sealing surface of the seal cap.

23. The downhole motor transmission of claim 22, wherein the sealing surface is a concave spherical surface.

24. The downhole motor transmission of claim 17, further comprising an end stop disposed on the shaft.

25. The downhole motor transmission of claim 24, wherein the biasing member is disposed between the end stop and the seal cap.

26. The downhole motor transmission of claim 25, wherein the seal member contacts a sealing surface of the seal cap.

27. The downhole motor transmission of claim 26, wherein the sealing surface is a concave spherical surface.

28. The downhole motor transmission of claim 27, wherein the seal member is integral to the one or more housings.

29. The downhole motor transmission of claim 16, wherein the fitting is substantially radially balanced.

30. The downhole motor transmission of claim 16, wherein the shaft is coupled to two housings.

31. The downhole motor transmission of claim 30, wherein one of the housings is connected to a rotor and the other housing is connected to an output shaft.

32. The downhole motor transmission of claim 16, wherein one housing is coupled to each end of the shaft.

33. The downhole motor transmission of claim 32, wherein the one or more housings further comprise an opening disposed at an end of the one or more housings for coupling with the shaft, wherein the opening is in fluid communication with the axial channel.

34. The downhole motor transmission of claim 33, wherein the shaft comprises an arcuate outer surface disposed at an end thereof.

35. The downhole motor transmission of claim 34, wherein the one or more housings include a seat having a concave surface for contacting the arcuate outer surface.
